(19) United States
(12) Patent Application Publication
(10) Pub. No.: US 2016/0288269 A1
(43) Pub. Date: Oct. 6, 2016

(54) PROCESS FOR COATING PREFORM WITH FLUX

(71) Applicant: GUANGZHOU SOLDERWELL ADVANCED MATERIALS CO., LTD., Guangzhou, Guangdong (CN)

(72) Inventors: Jinye Zhao, Guangzhou, Guangdong (CN); Fuhua Ye, Guangzhou, Guangdong (CN); Yan Lu, Guangzhou, Guangdong (CN); Hua Han, Guangzhou, Guangdong (CN); Minghan Chen, Guangzhou, Guangdong (CN); Yaolin Huang, Guangzhou, Guangdong (CN); Kun Du, Guangzhou, Guangdong (CN)

(21) Appl. No.: 15/031,284

(22) PCT Filed: Dec. 30, 2013
(86) PCT No.: PCT/CN2013/090930

§ 371 Date: Apr. 22, 2016

(30) Foreign Application Priority Data
Oct. 25, 2013 (CN) 201310509937.7

(51) Int. Cl. B23K 35/02; B05D 3/00; B05D 3/02; B05D 3/06; B05D 1/24; B05D 1/06

(52) U.S. Cl. CPC B23K 35/0244; B05D 1/24; B05D 1/06; B05D 3/0272; B05D 3/0263; B05D 3/029; B05D 3/067; B05D 3/002; B23K 2201/42

(57) ABSTRACT

A process for coating a preform with a flux is provided, which comprises: preform pretreatment, powder preparation, coating, curing, and post treatment. The process has the advantages of uniform and stable coating, highly controllable coating thickness, strong binding force, being efficient and environmentally friendly, and low cost, thus being suitable for coating the surface of various preforms with a flux.

### FIELD OF THE INVENTION

The present invention relates to the field of flux coating, and particularly to a process for coating a preform with a flux, which is especially suitable for coating the surface of various preforms with a flux.

### BACKGROUND OF THE INVENTION

Preform is a precisely formed solder that is fabricated, as desired, to have different shapes, sizes and surface morphologies, suitable for use in various manufacturing processes requiring a small tolerance, and widely used in printed circuit board (PCB) assembly, connector and terminal equipment, chip connection, attachment of power supply modules to a substrate, assembly of filter coupler and electronic components, and other areas. Therefore, the preform is generally utilized in a situation where the shape and quality of the solder are particularly required, and may be fabricated into any size and shape to meet the customer's requirements. Due to the advantages such as shape diversity, good weldability, reduced splashing of flux, and accurately controllable amount of metal when used alone, the preform is regarded as an important means in the technical innovation of welding.

To achieve a desirable effect of precise welding, the preform generally needs to be coated with a suitable flux.

Only a few invention patents concerning the technology for coating the surface of a preform with a flux are available at present, for example CN103056556A, CN101905386A, CN201711675U and CN202169445U. In these patents, a flux coating is obtained by impregnating a layer of liquid flux onto the surface of the preform, and then drying. Such a coating method has the following defects.

1) The liquid flux used contains a volatile organic solvent in most cases, which may cause environmental pollution and health hazards to operators.

2) The coating thickness is small, and the controllability is inadequate.

3) An amount of solvent is needed during the formulation and coating process of the flux, and removed finally by drying, such that the process is complex and the coating efficiency is low.

4) The cost is high, causing the waste of materials, energy and human resources.

### SUMMARY OF THE INVENTION

In view of the disadvantages of the above proprietary techniques in the prior art, the present invention provides an environmentally friendly process for coating a preform with a flux, which has the advantages of uniform and stable coating, highly controllable coating thickness, being efficient and environmentally friendly, and low cost.

To solve the above technical problems, the following technical solutions are employed in the present invention.

A process for coating a preform with a flux is provided, which comprises: preform pretreatment, powder preparation, coating, curing, and post treatment.

As an improvement of the present invention, the preform pretreatment in the present invention comprises degreasing, cleaning and drying the preform.

As an improvement of the present invention, the powder preparation in the present invention comprises:

1) preparing the flux into powder particles with a certain particle size directly;

2) preparing each component in the flux into powder particles and then mixing them uniformly;

3) mechanically mixing each component in the flux, and then preparing them into powder particles;

4) melt mixing each component in the flux, cooling, and preparing them into powder particles; and

5) uniformly mixing each component in the flux with a suitable amount of a dispersing agent, and preparing them into powder particles after removing the dispersing agent.

As an improvement of the present invention, the powder preparation in the present invention comprises preparing the flux into a powder with a particle size that is no more than 350 μm.

As an improvement of the present invention, the coating in the present invention comprises at least one of fluidized bed dip coating, thermal spraying, hot melt painting, electrostatic spraying, and electrostatic oscillation.

As an improvement of the present invention, the process parameters during the electrostatic spraying in the present invention comprise a spraying voltage of 30-100 kV, and a spraying distance of 10-25 cm.

As an improvement of the present invention, the curing in the present invention comprises heating curing and radiation curing.

As an improvement of the present invention, the heating in the present invention comprises resistance heating, infrared heating and microwave heating, and the radiation comprises UV light.

As an improvement of the present invention, the temperature of the heating curing in the present invention is 55-200° C.

As an improvement of the present invention, the post treatment in the present invention comprises natural cooling, forced cooling, compression molding, and cutting into a shape.

In the present invention, the preform is initially pretreated to obtain a clean and oil free surface. The absence of pretreatment or the presence of an undesirable pretreatment may cause the falling off of the coating, the vesiculation, and other problems, since the quality of the pretreatment has a direct impact on the quality of the powder coating. In the present invention, the preform is pretreated by chemical degreasing, cleaning and drying. For a preform with a surface cleanliness that meets the practical requirement, the pretreatment may be omitted, and the powder preparation and coating are carried out directly.

The preferred coating method in the present invention is electrostatic spraying, which specifically comprises the following steps. A flux that may be electrostatically charged is prepared into a powder with a certain particle size, and then the flux powder is sprayed onto the surface of a preform by using an electrostatic powder spraying apparatus. When the powder adhered has a certain thickness, no adsorption onto the preform takes place any more, due to the rule of “like electric charges repelling each other”, such that the thickness of the powder layer on each section of the surface of the preform is uniform. The layer of flux powder is softened, leveled, and cured by heating in an oven; and finally cooled and shaped, to obtain a uniform flux film that is closely bound to the preform. During the electrostatic spraying process, the factors affecting the coating quality include the electric conductivity of the flux powder, the particle size of the powder, the type of the powder spraying apparatus, the amount of the powder sprayed, the spraying voltage, the spraying time, the velocity gradient of the powder and air mixture, and others. Suitable process parameters may be selected in the present invention based on different fluxes, different coating thicknesses, and different requirements during use. Preferably, the particle size of the flux powder is no more than 350 μm, the spraying voltage is 30-100 kV, the spraying distance is 10-25 cm, and the curing temperature is 55-200° C.

In the conventional impregnation process with a liquid flux, the coating thickness is generally 10-20 μm (See Patent No. CN202169445U). In the present invention, the coating thickness can be up to 100-300 μm, and flux powders with varous particle sizes may be prepared and suitable spraying process parameters may be selected in the present invention according to practical requirements, to obtain flux films of various thicknesses. Therefore, the coating thickness is highly controllable in the present invention.

Compared with the prior art, the present invention has considerable beneficial effects. In the present invention, the electrostatic spraying technique is innovatively combined with the process for coating a preform with a flux, the flux contains no organic solvent, thus being energy saving and environmentally friendly, and causing no health hazards to the operators; the coating is uniform and stable, and the coating thickness is highly controllable; and the process is simple, the efficiency is high, and the cost is low. Therefore, the process of the present invention is suitable for coating the surface of various preforms with a flux.

### DETAILED DESCRIPTION OF THE EMBODIMENTS

### Example 1

A process for coating a preform with a flux is provided, which comprises: preform pretreatment, powder preparation, coating, curing, and post treatment. The steps specifically include:

1) degreasing and cleaning a round preform with a suitable amount of ethanol, and then drying;

2) preparing the flux directly into a powder with a particle size that is no more than 80 μm, and placing the powder in a fluidized bed;

3) properly preheating a preform, then placing it in the powder fluidized bed, and dip coating for a period of time;

4) placing and curing the powder coated preform in a resistance heating furnace at 80° C.; and

5) natural cooling and shaping.

The flux film coated following the above process is uniform and smooth, has a thickness of about 60 μm and has a strong binding force to the preform. Therefore, the coating effect is good.

### Example 2

A process for coating a preform with a flux is provided, which comprises: preform pretreatment, powder preparation, coating, curing, and post treatment. The steps specifically include:

1) degreasing and cleaning a round preform with a suitable amount of ethanol, and then drying;

2) preparing the flux directly into a powder with a particle size that is no more than 50 μm;

3) placing a suitable amount of the flux powder in an electrostatic spraying apparatus, and electrostatic spraying for a period of time with the spraying voltage being adjusted to 30 kV and the spraying distance being adjusted to 10 cm;

4) curing the powder coated preform by heating to 55° C. with IR; and

5) natural cooling and shaping.

The flux film coated following the above process is uniform and smooth, has a thickness of about 40 μm and has a strong binding force to the preform. Therefore, the coating effect is good.

### Example 3

A process for coating a preform with a flux is provided, which comprises: preform pretreatment, powder preparation, coating, curing, and post treatment. The steps specifically include:

1) degreasing and cleaning a circular preform with a suitable amount of ethanol, and then drying;

2) melt mixing each component in the flux, and preparing into a powder with a particle size that is no more than 350 μm after cooling;

3) placing a suitable amount of the flux powder in an electrostatic spraying apparatus, and electrostatic spraying for a period of time with the spraying voltage being adjusted to 100 kV and the spraying distance being adjusted to 25 cm;

4) curing the powder coated preform by heating to 200° C. with microwave; and

5) natural cooling, compressing and shaping.

The flux film coated following the above process is uniform and smooth, has a thickness of about 200 μm and has a strong binding force to the preform. Therefore, the coating effect is good.

### Example 4

A process for coating a preform with a flux is provided, which comprises: preform pretreatment, powder preparation, coating, curing, and post treatment. The steps specifically include:

1) degreasing and cleaning a rectangular preform with a suitable amount of ethanol, and then drying;

2) preparing each component in the flux into powders with a particle size that is no more than 100 μm, and then mixing them uniformly;

3) placing a suitable amount of the flux powder in an electrostatic spraying apparatus, and electrostatic spraying for a period of time with the spraying voltage being adjusted to 50 kV and the spraying distance being adjusted to 15 cm;

4) curing the powder coated preform with UV light; and

5) post treatment, for example, polishing, trimming and cutting, as desired.

The flux film coated following the above process is uniform and smooth, has a thickness of about 80 μm and has a strong binding force to the preform. Therefore, the coating effect is good.

It should be noted that the foregoing descriptions are merely preferred embodiments of the present invention, and the protection scope of the present invention is not limited thereto. Replacements made simply by those of skill in the art based on the embodiments are all embraced in the protection scope as defined by the claims of present invention.

What is claimed is:

1. A process for coating a preform with a flux, comprising preform pretreatment, powder preparation, coating, curing, and post treatment.

2. The process for coating a preform with a flux according to claim 1, wherein the preform pretreatment comprises degreasing, cleaning and drying the preform.

3. The process for coating a preform with a flux according to claim 1, wherein the powder preparation comprises:
1) preparing the flux into powder particles with a certain particle size directly;
2) preparing each component in the flux into powder particles and then mixing them uniformly;
3) mechanically mixing each component in the flux, and then preparing them into powder particles;
4) melt mixing each component in the flux, cooling, and preparing them into powder particles; and
5) uniformly mixing each component in the flux with a suitable amount of a dispersing agent, and preparing them into powder particles after removing the dispersing agent.

4. The process for coating a preform with a flux according to claim 1, wherein the powder preparation comprises preparing the flux into a powder with a particle size that is no more than 350 μm.

5. The process for coating a preform with a flux according to claim 1, wherein the coating comprises at least one of fluidized bed dip coating, thermal spraying, hot melt painting, electrostatic spraying, and electrostatic oscillation.

6. The process for coating a preform with a flux according to claim 1, wherein the process parameters during the electrostatic spraying comprise a spraying voltage of 30-100 kV, and a spraying distance of 10-25 cm.

7. The process for coating a preform with a flux according to claim 1, wherein the curing comprises heating curing and radiation curing.

8. The process for coating a preform with a flux according to claim 7, wherein the heating comprises resistance heating, infrared heating and microwave heating, and the radiation comprises UV light.

9. The process for coating a preform with a flux according to claim 7, wherein the temperature of the heating curing is 55-200° C.

10. The process for coating a preform with a flux according to claim 1, wherein the post treatment comprises natural cooling, forced cooling, compression molding, and cutting into a shape.
